(19) United States
(12) Patent Application Publication
(10) Pub. No.: US 2009/0248219 A1
(43) Pub. Date: Oct. 1, 2009

(54) DEVICE THAT ENABLES A VEHICLE TO BE MOVED WHEN A DISASTER OCCURS

(75) Inventors: Hiroshi KAWAUCHI, Okazaki-shi, (JP); Takamitsu SAKAI, Okazaki-shi, (JP); Takaaki NAKAYAMA, Okazaki-shi, (JP)

Correspondence Address: LOWE HAUPTMAN HAM & BERNER, LLP, 1700 DIAGONAL ROAD, SUITE 300, ALEXANDRIA, VA, 22314, US

(73) Assignee: AISIN AW CO., LTD., Aichi (JP)

(21) Appl. No.: 12/368,476

(22) Filed: Feb. 10, 2009

(30) Foreign Application Priority Data
Mar. 31, 2008 (JP) 2008-089812

(51) Int. Cl. B60W 50/00

(52) U.S. Cl. 701/1

(57) ABSTRACT

A device that enables a vehicle to be moved when a disaster occurs includes a forced engine start unit and a constraint unit. When it is detected that the vehicle has stopped after a disaster detection signal is received, the position where the vehicle has stopped is stored. Thereafter, the forced engine start unit enables the engine of the vehicle to be started by a start switch, without using an ignition key. The constraint unit restricts the moving of the vehicle by the forced engine start unit.

### INCORPORATION BY REFERENCE

The disclosure of Japanese Patent Application No. 2008-089812 filed on Mar. 31, 2008, including the specification, drawings and abstract is incorporated herein by reference in its entirety.

### BACKGROUND OF THE INVENTION

The present invention relates to a device that enables a vehicle to be moved in extraordinary circumstances, such as after a disaster such as an earthquake or the like has occurred, a device that makes it possible, when necessary, for a third party to move a vehicle such as an automobile or the like that has been left on a road after its occupants have evacuated. In particular, the present invention relates to a device that allows a third party to move even a vehicle from which a drive mechanism starting key, such as an ignition key or the like, has been removed.

### DESCRIPTION OF THE RELATED ART

Large-scale earthquakes have frequently occurred in every region of Japan in recent years. When disasters such as large earthquakes, fires in tunnels, floods, tsunamis, and the like occur, the occupants of vehicles such as automobiles and the like, including the drivers, must stop their vehicles promptly and seek refuge. However, while known car navigation devices have functions that display road congestion information and the like and provide voice guidance, functions that indicate suitable escape routes when a disaster occurs have not been provided.

Accordingly, an evacuation guidance system for a vehicle that addresses this issue is disclosed in Japanese Patent Application Publication No. JP-A-2008-021030.

Specifically, the evacuation guidance system for a vehicle is provided with a disaster location information acquisition unit, a vehicle location detection unit, an evacuation guidance information creation unit, and an evacuation guidance information output unit. The disaster location information acquisition unit acquires, from an external source, location information on a disaster that has occurred in a defined zone. The vehicle location detection unit detects the vehicle's location in the defined zone. The evacuation guidance information creation unit, based on evacuation facility information that is stored in an evacuation facility information storage unit, as well as on the disaster location information and information on the vehicle's location, creates evacuation guidance information for guiding the occupants of the vehicle out of the defined zone. The evacuation guidance information output unit outputs the evacuation guidance information that is created.

The technological concept that is disclosed is to provide guidance to the occupants on how to evacuate in the event of a disaster and also to make it possible for the occupants to select an appropriate evacuation site and to know what has happened to the occupants of other vehicles.

The evacuation guidance system for a vehicle provides guidance to the vehicle's occupants on how to evacuate in the event of a disaster and also makes it possible for the occupants to select an appropriate evacuation site and to know what has happened to the occupants of other vehicles.

### SUMMARY OF THE INVENTION

However, Japanese Patent Application Publication No. JP-A-2008-021030 makes no mention whatsoever of a method for dealing with a case where it is necessary to move a vehicle that is left behind after the occupants have evacuated. In a case where the occupants abandon the vehicle when they evacuate after a disaster such as an earthquake or the like has occurred, it is recommended that they leave the ignition key in the vehicle so that a third party can move the abandoned vehicle if necessary. However, because of the possibility that the vehicle will be stolen, it cannot be expected that all drivers will leave the ignition keys in their vehicles. Furthermore, for the sake of the conscientious driver who leaves the ignition key in the vehicle when he abandons it, it is necessary to reliably prevent the vehicle from being stolen.

Accordingly, the present invention provides a device that enables a vehicle to be moved when a disaster occurs that, in a case where a need arises to move a vehicle that has been abandoned after a disaster, makes it possible for a third party to move the vehicle even if the ignition key has been removed and that also can prevent the vehicle from being stolen.

According to a first aspect, the device that enables a vehicle to be moved when a disaster occurs, after a disaster detection signal is received from a disaster occurrence detection unit that detects the occurrence of a disaster, and after a vehicle stop detection unit that outputs a vehicle engine stop detection signal detects that the vehicle's engine has stopped, can enable the vehicle to be moved, subject to a constraint that is imposed by a constraint unit that allows the engine to be started by using a start switch and without using an ignition key and restricts the moving of the vehicle.

In this case, the disaster whose occurrence is detected by the disaster occurrence detection unit may be a large-scale earthquake, as well as a large fire, a fire in a tunnel, a tsunami, a typhoon, a flood, and the like where using the vehicle to evacuate is dangerous.

The vehicle stop detection unit that detects that the vehicle's engine has stopped and outputs the stop detection signal actually detects that the ignition switch is turned off, to be more precise. That is, in the case of a keyless entry system, where as long as the driver has the ignition key, even if he does not take it out of his pocket, a receiver in the vehicle can receive radio waves that are broadcast from the ignition key, such that the driver can open the doors, get into the vehicle, and start the engine just by pressing a start switch, the detecting that the vehicle's engine has stopped can be accomplished by detecting that the vehicle speed is zero and by detecting that the parking brake has been engaged. Note that the engine may be a gasoline engine in a gasoline vehicle, a diesel engine in a diesel vehicle, an electric motor in a fuel cell vehicle, or the like.

A forced engine start unit may be any sort of ignition switch that can start the engine without using the ignition key after the disaster detection signal is received from the disaster occurrence and after the vehicle engine stop detection signal is received from the vehicle stop detection unit.

The constraint unit may be any unit that restricts the moving of the vehicle by the forced engine start unit, can impose a restriction such as a distance restriction, a restriction on the elapsed time since the vehicle stopped, a moving time restriction, a road link level restriction, a specific direction restriction, such as a homeward direction or the like, and the like.

According to a second aspect, the disaster occurrence detection unit of the device that enables a vehicle to be moved when a disaster occurs may one of detect at least one of the P waves and the S waves that are generated by an earthquake and receive earthquake information that is broadcast by radio when an earthquake occurs.

In this case, the disaster occurrence detection unit is a unit that one of detects at least one of the P waves and the S waves that are generated by an earthquake and receives earthquake information that is broadcast by radio when an earthquake occurs. Obviously, the disaster occurrence detection unit receives disaster information that is broadcast, in addition to detecting at least one of the P waves and the S waves that are generated by an earthquake.

According to a third aspect, the constraint unit of the device that enables a vehicle to be moved when a disaster occurs may include an elapsed time measurement unit and a movement distance restriction unit. The elapsed time measurement unit measures the elapsing of a specified time since the stopping of the engine of the vehicle was detected by the vehicle stop detection unit, and the movement distance restriction unit specifies a distance that the vehicle can be moved in a case where the engine is started by the forced engine start unit. The constraint unit stops the engine of the vehicle according to one of whether the specified time has elapsed since the stopping of the engine of the vehicle due to the detection of the occurrence of a disaster was detected and whether the vehicle has been moved the specified distance after the engine has been started by the forced engine start unit.

In this case, the constraint unit may use the elapsed time measurement unit that measures the elapsing of the specified time since the stopping of the engine of the vehicle was detected to impose a restriction on the time that elapses since the time that the engine was stopped and may also use the movement distance restriction unit, which measures the distance that the vehicle has been moved from the location where it was stopped, to impose a restriction on the distance that the vehicle can be moved from the location where it was stopped. Note that the elapsed time measurement unit may be any unit that measures the elapsing of the specified time since the stopping of the engine of the vehicle was detected by the vehicle stop detection unit. Further, the movement distance restriction unit may be any unit that restricts the distance that the vehicle can be moved in a case where the engine is started by the forced engine start unit.

According to a fourth aspect, the constraint unit of the device that enables a vehicle to be moved when a disaster occurs, when the vehicle stop detection unit detects that the engine of the vehicle has stopped, may entrust control of the vehicle to a vehicle control center that controls starting of the engine of the vehicle, such that the starting of the engine by the forced engine start unit may be enabled by a receiving of permission from the vehicle control center.

In this case, the vehicle control center is an organization that, for the purpose of preventing a member's vehicle from being stolen, controls the vehicle by using radio communication to give permission for the engine to be operated and monitoring the vehicle's position while it is being moved.

According to a fifth aspect, the device that enables a vehicle to be moved when a disaster occurs may also include a vehicle position storage unit that stores the position of the vehicle when the vehicle stop detection unit, which outputs the stop detection signal, detects that the engine of the vehicle has stopped after the disaster detection signal has been received from the disaster occurrence detection unit, which detects the occurrence of a disaster. Then, after the vehicle engine stop detection signal is received from the vehicle stop detection unit, the vehicle can be moved, subject to the constraint that is imposed by the constraint unit that allows the engine to be started by using the start switch and without using the ignition key and restricts the moving of the vehicle.

In this case, the disaster whose occurrence is detected by the disaster occurrence detection unit may be a large-scale earthquake, as well as a large fire, a fire in a tunnel, a tsunami, a typhoon, a flood, and the like where using the vehicle to evacuate is dangerous.

The vehicle stop detection unit that detects that the vehicle's engine has stopped and outputs the stop detection signal may actually detect that the ignition switch is turned off, to be more precise. That is, in the case of a keyless entry system, where as long as the driver has the ignition key, even if he does not take it out of his pocket, a receiver in the vehicle can receive radio waves that are broadcast from the ignition key, such that the driver can open the doors, get into the vehicle, and start the engine just by pressing a start switch, the detecting that the vehicle's engine has stopped can be accomplished by detecting that the vehicle speed is zero and by detecting that the parking brake has been engaged. Note that the engine may be a gasoline engine in a gasoline vehicle, a diesel engine in a diesel vehicle, an electric motor in a fuel cell vehicle, or the like.

The vehicle position storage unit may be any unit that, when the vehicle stop detection unit detects that the engine of the vehicle has stopped after the disaster detection signal has been received from the disaster occurrence detection unit, uses a GPS-equipped known navigation function to detect the current position of the vehicle and stores the current position data in a non-volatile memory.

The forced engine start unit may be any sort of ignition switch that can start the engine without using the ignition key after the disaster detection signal is received from the disaster occurrence detection unit and after the vehicle engine stop detection signal is received from the vehicle stop detection unit.

The constraint unit may be any unit that restricts the moving of the vehicle by the forced engine start unit, can impose a restriction such as a distance restriction, a restriction on the elapsed time since the vehicle stopped, a moving time restriction, a road link level restriction, a specific direction restriction, such as a homeward direction or the like, and the like.

According to a sixth aspect, the constraint unit of the device that enables a vehicle to be moved when a disaster occurs may also limit a distance that the vehicle can be moved after the engine is started by the forced engine start unit to within a specified radius from the position where the engine of the vehicle stopped.

In this case, limiting the distance that the vehicle can be moved by a third party, instead of by the evacuated driver, to within the specified radius from the position where the engine of the vehicle stopped makes it possible to select a location to which the vehicle is to be moved based on the specified radius. Note that the specified radius from the position where the engine of the vehicle stopped does not represent a boundary, for example, but is determined based on the efficiency of a human survey of the area defined by the radius. It is not the case that a value greater than a certain percent cannot be used for the specified radius. Since the area of a circle is proportionate to the square of the radius (πr²), if the radius is increased, the time required to survey the area will increase in proportion to the square of the radius.

According to a seventh aspect, the device that enables a vehicle to be moved when a disaster occurs may also include, within the constraint unit, a voice guidance unit that provides voice guidance with regard to at least one of a remaining distance and a remaining time that the vehicle can be moved after the engine has been started by the forced engine start unit.

In this case, because there is a possibility that the constraint unit may stop the moving of the vehicle abruptly, the voice guidance unit can provide guidance, in the form of at least one of a voice and a visual display, with regard to a condition for stopping the engine of the vehicle.

According to an eighth aspect, the constraint unit of the device that enables a vehicle to be moved when a disaster occurs may also include a password input unit that uses input of a specified password to cancel a constraint condition.

In this case, inputting the specified password enables the constraint unit to cancel the constraint condition.

According to a ninth aspect, the device that enables a vehicle to be moved when a disaster occurs may also determine a link level of the road on which the vehicle was traveling when the vehicle stop detection unit detected that the engine of the vehicle was stopped, and the constraint unit may set a constraint condition according to the link level.

The link levels of the roads may be defined, for example, such that a link level 0 indicates a freeway class road (1), a link level 1 indicates a freeway class road (2), a link level 2 indicates a highway class road, a link level 3 indicates a throughway class road, a link level 4 indicates a local road class road, and the like. In a case where the road on which the engine of the vehicle has stopped has the link level 0 that indicates a freeway class road (1), there is a strong possibility that the vehicle cannot be moved to a highway class road until it reaches an interchange, so the distance that the vehicle can be moved is set to a greater value. A vehicle that is stopped on a road with the link level 1 that indicates a freeway class road (2) is normally moved to a road with a lower link level, such as the link level 2 that indicates a highway class road, or the like. Therefore, the constraint condition can be set such that moving to a lower link level is permitted, but moving to a higher link level is not permitted.

According to a tenth aspect, the device that enables a vehicle to be moved when a disaster occurs may also determine the link level of the road on which the vehicle was traveling when the vehicle stop detection unit detected that the engine of the vehicle was stopped, and the constraint unit may stop the vehicle if the road on which the vehicle is being moved has a higher link level than the road where the engine of the vehicle was stopped.

In this case, the normal way to evacuate, for example, a vehicle that is stopped on a road with the link level 1 that indicates a freeway class road (2) is to move it to a road with a lower link level, such as the link level 2 that indicates a highway class road, or the like. Therefore, moving a vehicle to a road with a higher link level, such as from a highway class road with the link level 2 to a freeway class road (1) with the link level 0, is not permitted.

In the first aspect of the device that enables a vehicle to be moved when a disaster occurs, after the occurrence of a disaster is detected and the disaster detection signal is received, and after the stopping of engine of the vehicle is detected and the stop detection signal is received, even though the engine can be started by using the start switch and without using the ignition key, the moving of the vehicle is restricted by the constraint unit.

Therefore, when a disaster occurs, the disaster occurrence detection unit outputs the disaster detection signal, and when the driver stops the vehicle in order to evacuate, the vehicle stop detection unit outputs the stop detection signal, so both the disaster detection signal and the stop detection signal are received. Then the forced engine start unit is enabled to use the start switch to start the engine without using the ignition key. Thus the engine is put into a state in which it can be started even in a case where the driver has removed the ignition key and fled. The abandoned vehicle can therefore be moved even by a third party who does not have the ignition key.

Furthermore, even in a case where the vehicle is moved by a third party, the constraint unit can restrict the moving of the vehicle by the forced engine start unit. The constraint unit restricts the moving of the vehicle by imposing a restriction such as a distance restriction, a restriction on the elapsed time since the vehicle stopped, a moving time restriction, a road link level restriction, a specific direction restriction, such as a homeward direction or the like, and the like, thus providing a function that prevents the vehicle from being stolen.

Therefore, in a case where a need arises to move a vehicle that has been abandoned when a disaster occurs, it is possible for a third party to move the vehicle even if the ignition key has been removed, and it is also possible to prevent the vehicle from being stolen.

In the second aspect, the disaster occurrence detection unit of the device that enables a vehicle to be moved when a disaster occurs may one of detect at least one of the P waves and the S waves that are generated by an earthquake and receive earthquake information that is broadcast by radio when an earthquake occurs. Therefore, in addition to the effects described in the first aspect, one of detecting a tremor and receiving a broadcast in the event of an earthquake makes it possible for a disaster response is to be made, and because the disaster response can be made quickly in the case of a large-scale earthquake, the abandoned vehicle does not become an obstacle to recovery after the disaster.

In the third aspect, the constraint unit of the disaster occurrence detection unit of the device that enables a vehicle to be moved when a disaster occurs may include the elapsed time measurement unit and the movement distance restriction unit. The elapsed time measurement unit measures the elapsing of the specified time since the stopping of the engine of the vehicle was detected by the vehicle stop detection unit, and the movement distance restriction unit specifies the distance that the vehicle can be moved in a case where the engine is started by the forced engine start unit. The constraint unit stops the engine of the vehicle according to one of whether the specified time has elapsed since the stopping of the engine of the vehicle due to the detection of the occurrence of a disaster was detected and whether the vehicle has been moved the specified distance after the engine has been started by the forced engine start unit. Therefore, in addition to the effects described in the first and second aspects, because the vehicle's engine is stopped for one of two reasons, one reason being that the elapsed time measurement unit, which measures the specified time that elapses after the stopping of the vehicle's engine was detected, detects that the specified time has elapsed since the stopping of the vehicle's engine was detected, and the other reason being that, after the engine has been started by the forced engine start unit, the vehicle has been moved the specified distance that is set by the movement distance restriction unit, the distance that the vehicle can be moved is limited. Thus, even in a case where the driver searches for his own vehicle, the search can be done efficiently, because the driver needs to search only within a limited distance.

In the fourth aspect, the constraint unit of the disaster occurrence detection unit of the device that enables a vehicle to be moved when a disaster occurs, when the stopping of the vehicle's engine is detected, may entrust control of the vehicle to the vehicle control center, such that the starting of the engine by the forced engine start unit may be enabled by the receiving of permission from the vehicle control center. Therefore, in addition to the effects described in any one of the first to third aspects, the vehicle control center controls the location to which the vehicle is moved, eliminating any concern that the vehicle will be stolen or lost.

In the fifth aspect of the device that enables a vehicle to be moved when a disaster occurs, the position of the vehicle is stored when the stopping of the vehicle's engine is detected and the stop detection signal is received after the occurrence of a disaster is detected and the disaster detection signal has been received. After both the disaster detection signal and the stop detection signal have been received, the constraint unit restricts the moving of the vehicle even though the engine can be started by the start switch without using the ignition key.

Therefore, when a disaster occurs, the disaster occurrence detection unit outputs the disaster detection signal, and when the driver stops the vehicle in order to evacuate, the vehicle stop detection unit outputs the stop detection signal, so both the disaster detection signal and the stop detection signal are received, and the vehicle position storage unit stores the position of the vehicle. Then the forced engine start unit is enabled to use the start switch to start the engine without using the ignition key. Thus the engine is put into a state in which it can be started even in a case where the driver has removed the ignition key and fled. The abandoned vehicle can therefore be moved even by a third party who does not have the ignition key.

Furthermore, even in a case where the vehicle is moved by a third party, the constraint unit can restrict the moving of the vehicle by the forced engine start unit. The constraint unit restricts the moving of the vehicle by imposing a restriction such as a distance restriction, a restriction on the elapsed time since the vehicle stopped, a moving time restriction, a road link level restriction, a specific direction restriction, such as a homeward direction or the like, and the like, thus providing a function that prevents the vehicle from being stolen.

Therefore, in a case where a need arises to move a vehicle that has been abandoned when a disaster occurs, it is possible for a third party to move the vehicle even if the ignition key has been removed, and it is also possible to prevent the vehicle from being stolen.

In the sixth aspect, the constraint unit of the disaster occurrence detection unit of the device that enables a vehicle to be moved when a disaster occurs may limit the distance that the vehicle can be moved after the engine is started by the forced engine start unit to within a specified radius from the position where the engine of the vehicle stopped. Therefore, in addition to the effects described in the fifth aspect, because the distance that the vehicle can be moved is limited, in a case where the driver searches for his own vehicle, the search can be done efficiently, because the vehicle can be located within a specified time in almost every case.

In the seventh aspect, the constraint unit of the disaster occurrence detection unit of the device that enables a vehicle to be moved when a disaster occurs may also include the voice guidance unit that provides voice guidance with regard to at least one of the remaining distance and the remaining time that the vehicle can be moved after the engine has been started by the forced engine start unit. Therefore, in addition to the effects described in any one of the first to sixth aspects, because the guidance with regard to at least one of the remaining distance and the remaining time that the vehicle can be moved is provided in the form of at least one of a voice and a display, a third party who is driving the vehicle can understand at least one of the remaining distance and the remaining time that the vehicle can be moved and can therefore respond appropriately.

In the eighth aspect, the constraint unit of the disaster occurrence detection unit of the device that enables a vehicle to be moved when a disaster occurs may also include the password input unit that uses the input of the specified password to cancel the constraint condition. Therefore, in addition to the effects described in any one of the first to seventh aspects, inputting the specified password enables the constraint unit to cancel the constraint condition. A legitimate driver can therefore move the vehicle without being affected by the constraint unit, even if the ignition key has been lost or forgotten.

In the ninth aspect, the disaster occurrence detection unit of the device that enables a vehicle to be moved when a disaster occurs may also determine a link level of the road on which the vehicle was traveling when the vehicle stop detection unit detected that the engine of the vehicle was stopped, and the constraint unit may set a constraint condition according to the link level. Therefore, in addition to the effects described in any one of the first to eighth aspects, it is possible to respond in a manner that is suited to the link level of the road, because the constraint condition that is set for the movement of the vehicle will vary according to the road on which the vehicle is stopped.

In the tenth aspect, the disaster occurrence detection unit of the device that enables a vehicle to be moved when a disaster occurs may also determine the link level of the road on which the vehicle was traveling when the vehicle stop detection unit detected that the engine of the vehicle was stopped, and the constraint unit, when the engine is started by the forced engine start unit and the vehicle is moved, may stop the vehicle if the road on which the vehicle is being moved has a higher link level than the road where the engine of the vehicle was stopped. Therefore, in addition to the effects described in any one of the first to ninth aspects, the effect hereinafter described can be provided. The link levels of the roads may be defmed, for example, such that a link level 0 indicates a freeway class road (1), a link level 1 indicates a freeway class road (2), a link level 2 indicates a highway class road, a link level 3 indicates a throughway class road, a link level 4 indicates a local road class road, and the like. The normal, common-sense way to evacuate is to move to roads with successively lower link levels, so moving the vehicle in the opposite direction, to a road with a higher link level, is prohibited, and the moving of the vehicle is enabled only in a case where the vehicle is moved to a road with a lower link level.

### BRIEF DESCRIPTION OF THE DRAWINGS

FIG. 1 is a block diagram that shows an overall configuration of a device that enables a vehicle to be moved when a disaster occurs according to a first embodiment of the present invention, in which the overall configuration includes an expression of a navigation function;

FIG. 2 is a flowchart of a disaster detection program for the device that enables a vehicle to be moved when a disaster occurs according to the first embodiment of the present invention;

FIG. 3 is a flowchart of a disaster response program for the device that enables a vehicle to be moved when a disaster occurs according to the first embodiment of the present invention;

FIG. 4 is an explanatory figure that shows a ranking of link levels that is used by the device that enables a vehicle to be moved when a disaster occurs according to the first embodiment of the present invention;

FIG. 5 is an explanatory figure in which a constraint condition for the device that enables a vehicle to be moved when a disaster occurs according to the first embodiment of the present invention is set to a range with a radius of approximately one kilometer; and

FIG. 6 is a block diagram that shows an overall configuration of a device that enables a vehicle to be moved when a disaster occurs according to a second embodiment of the present invention, in which the overall configuration includes an expression of a navigation function.

### DETAILED DESCRIPTION OF THE EMBODIMENTS

Hereinafter, embodiments of the present invention will be explained with reference to the drawings. Note that in the embodiments, parts that have identical or equivalent functions are indicated by identical symbols and identical reference numbers in the drawings, so duplicate explanations will be omitted.

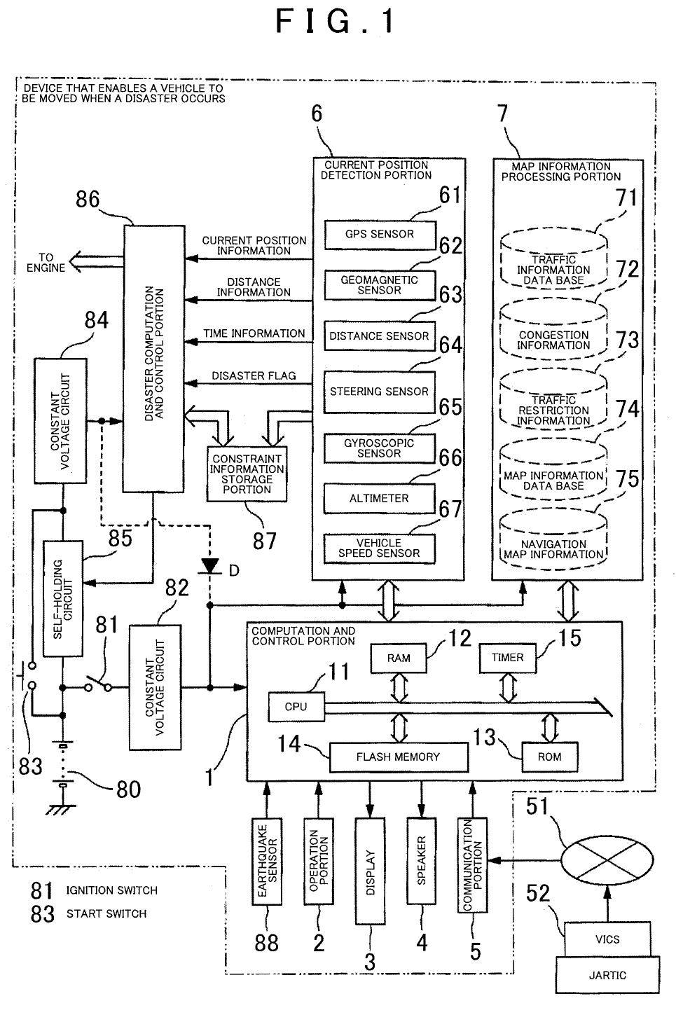

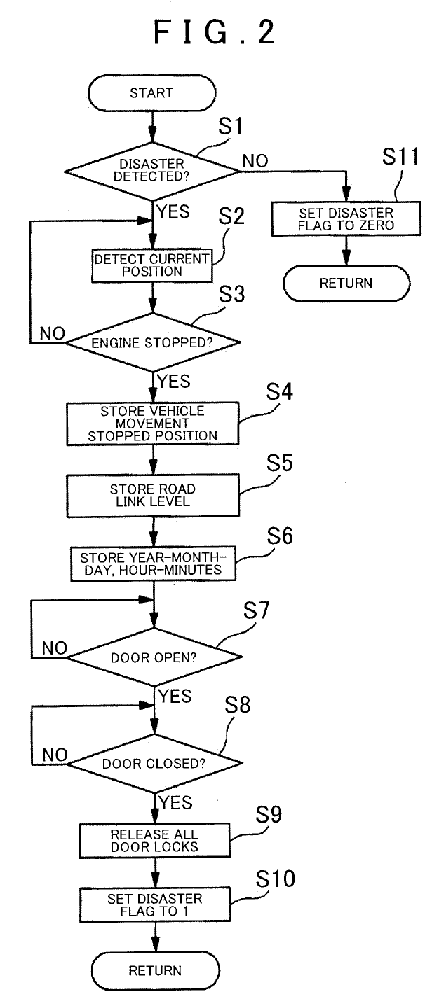

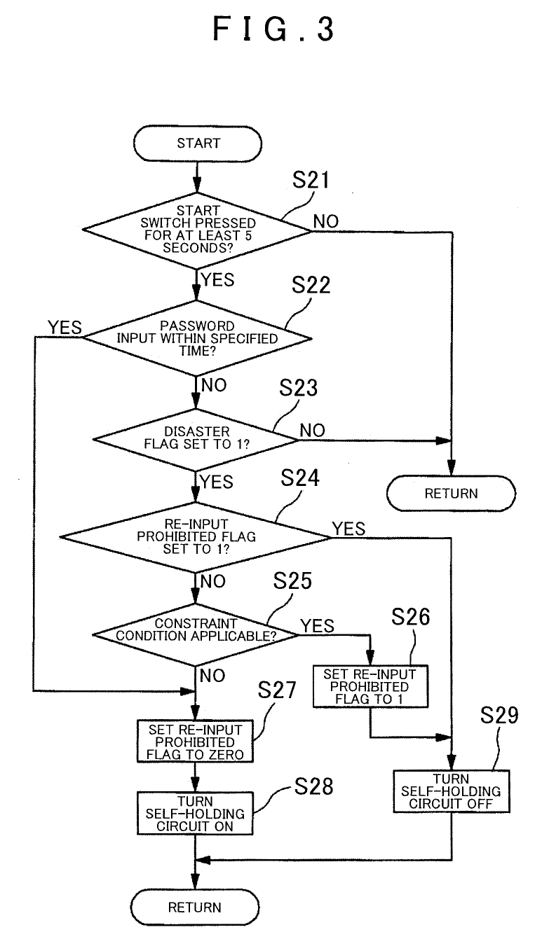

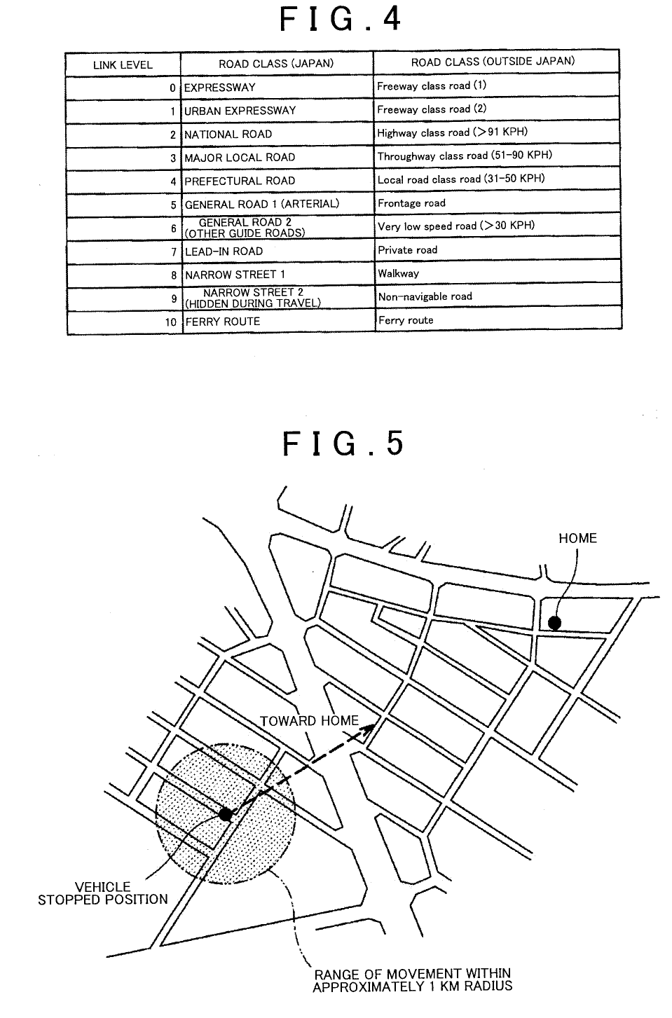

FIG. 1 is a block diagram that shows an overall configuration of a device that enables a vehicle to be moved when a disaster occurs according to a first embodiment of the present invention, in which the overall configuration includes an expression of a navigation function. FIG. 2 is a flowchart of a disaster detection program for the device that enables a vehicle to be moved when a disaster occurs according to the first embodiment of the present invention. FIG. 3 is a flowchart of a disaster response program for the device that enables a vehicle to be moved when a disaster occurs according to the first embodiment of the present invention. FIG. 4 is an explanatory figure that shows a ranking of link levels that is used by the device that enables a vehicle to be moved when a disaster occurs according to the first embodiment of the present invention. FIG. 5 is an explanatory figure in which a constraint condition for the device that enables a vehicle to be moved when a disaster occurs according to the first embodiment of the present invention is set to a range with a radius of approximately one kilometer.

### First Embodiment

In FIG. 1, the device that enables a vehicle to be moved when a disaster occurs according to the first embodiment includes a computation and control portion 1, an operation portion 2, a display 3, and a speaker 4. The computation and control portion 1 includes a microprocessor that performs various types of computational processing based on information that is input. The operation portion 2 includes various types of keys, touch switches, and the like that accept operations by an operator such as a driver or the like in the form of key inputs, voice inputs, and the like. The display 3 includes a liquid crystal display that displays information such as operating information, map information, and the like for the operator. The speaker 4 outputs voice guidance that pertains to route guidance, traffic restriction information, traffic congestion information, and the like. Note that a keyboard, a mouse, a bar code reader, a remote control device for remote operation, and the like may be used as the operation portion 2. The operation portion 2 may also be configured in the form of a touch panel that is provided on a front face of the display 3.

The computation and control portion 1 that includes the microprocessor is provided with a CPU 11, a RAM 12, a ROM 13, an internal storage device such as a flash memory 14 or the like, and a timer 15. The CPU 11 performs computations and overall control. The RAM 12 is used as a working memory for various types of computational processing that the CPU 11 performs and also stores route search data, route data on a route that is found, traffic restriction information, traffic congestion information, and the like. The ROM 13 stores a control program, as well as bypass road information, a program that computes a required time for each of a plurality of merging points, and the like. The internal storage device such as the flash memory 14 or the like stores a program that is read out from the ROM 13. The timer 15 measures time. In the present embodiment, the timer 15 configures an elapsed time measurement unit that measures a specified time that elapses after a stopping of the vehicle's engine is detected.

Various types of programs are stored in the ROM 13, and various types of data are stored in the RAM 12. Programs, data, and the like are also read out from an external storage device, a memory card, or the like and written to the flash memory 14. The programs, the data, and the like can also be updated by replacing the memory card or the like, and by installing specified programs, data, and the like from an external source.

Various peripheral devices, such as the operation portion 2, the display 3, the speaker 4, a communication portion 5, and the like, are electrically connected to the computation and control portion 1. The operation portion 2 is configured from a plurality of operation switches, such as various keys and the like, that are operated when the current position is corrected when the vehicle starts moving, when a departure point is input as a guidance start point, when a destination is input as a guidance end point, when a search for information that pertains to facilities is performed, and the like. Based on switch signals that are output by operations of the various switches of the operation portion 2, the computation and control portion 1 performs control of the various types of corresponding operations.

The display 3 displays operation guidance, an operation menu, key guidance, route guidance from the current position to a destination, guidance information along the route, route change guidance information that will be described later, traffic information, news, a weather forecast, the time, e-mail, a television program, and the like.

Note that instead of the liquid crystal display, a CRT display, a plasma display, an EL display, or the like can be used as the display 3. A hologram device that projects a hologram on the front windshield of the vehicle can also be used as the display 3. The display 3 may also include a touch panel that is used as the operation portion 2. The speaker 4, based on a command from the computation and control portion 1, outputs voice guidance that provides guidance for driving on main roads and bypass roads, as well as voice guidance that provides guidance on changing the route for which the route guidance is provided. Note that the voice guidance that the speaker 4 outputs can be a synthesized voice and can also include various types of sound effects and various types of guidance information that are stored in memory in advance.

The device that enables a vehicle to be moved when a disaster occurs also includes the communication portion 5. The communication portion 5 performs communication with at least one information center through a network 51. The information center may be the Japan Road Traffic Information Center (JARTIC (registered trademark)) (hereinafter simply called JARTIC), which broadcasts traffic information by AM radio (at a frequency of 1620 kHz), and may also be the Vehicle Information and Communication System (VICS (registered trademark)) (hereinafter simply called VICS) 52.

In the present embodiment, road traffic information such as information pertaining to traffic congestion and the like, as well as traffic restriction information and the like, that is prepared from information that is collected by traffic control systems of the police, the Japan Public Highway Corporation (registered trademark), and the like, can be received from VICS 52 at specified time intervals through the network 51. The road traffic information is detailed information that pertains, for example, to road traffic information such as road congestion information that pertains to road congestion and the like, as well as information on traffic restrictions and the like due to road work, building construction work, and the like. In the case of the road congestion information, the detailed information includes a VICS link ID that will be described later, the actual length of the congestion, the estimated time that the congestion will be resolved, and the like. In the case of the traffic restriction information, the detailed information includes the VICS link ID, a period of time that the road work, building construction work, or the like will continue, a type of traffic restrictions, such as a closed road, a location where traffic moves through in alternating directions in one lane, a lane restriction, or the like, a time period for the traffic restriction, and the like.

A communication system such as a wireless local area network (LAN), a wide area network (WAN), a telephone network, a public communication network, a dedicated communication network, or the like, for example, can be used as the network 5 1. A communication system that utilizes CS broadcasting by satellite, BS broadcasting, terrestrial digital broadcasting, FM multiplex broadcasting, or the like can also be used. Further, a non-stop Electronic Toll Collection (ETC) system, a Dedicated Short Range Communication (DSRC) system, or the like that is used in Intelligent Transportation Systems (ITS) can also be used.

The communication portion 5 may be, for example, a beacon receiver that receives various types of road traffic information that is transmitted from VICS 52 or the like, including congestion information, traffic restriction information, parking site information, traffic accident information, service area crowding statuses, and the like, in the form of a radio beacon, an optical beacon, or the like through a radio beacon device, an optical beacon device, or the like that is installed along the road. The communication portion 5 may also be a network device that is capable of communication in the communication system that serves as the network 51, such as a communication network or the like. The communication portion 5 also includes an FM receiver that receives not only the information from VICS 52, but also FM multiplex information that includes information such as disaster information, news, a weather forecast, and the like as FM multiple broadcasting via FM broadcast. Note that the beacon receiver and the FM receiver can be provided in the form of a single receiver unit and can also be provided separately.

The device that enables a vehicle to be moved when a disaster occurs according to the present embodiment also includes a current position detection portion 6 and a map information processing portion 7. The current position detection portion 6 detects the current position of the vehicle and includes various types of sensors that make it possible for the current position and heading of the vehicle, the distance to a target position (for example, an intersection), and the like to be detected. Similarly, the map information processing portion 7 includes a hard disk with a large storage capacity, such that various types of geographic data can be stored, written, and read.

The characteristic configuring elements that are included in the device that enables a vehicle to be moved when a disaster occurs according to the present embodiment will be explained more specifically with reference to FIG. 1.

The current position detection portion 6 includes a GPS sensor 61, a geomagnetic sensor 62, a distance sensor 63, a steering sensor 64, a gyroscopic sensor 65 that serves as a heading detection portion, and an altimeter 66, as well as a vehicle speed sensor 67 that detects the speed of the vehicle and the distance traveled. Note that the distance sensor 63 and the vehicle speed sensor 67 can be a single unit.

In the present embodiment specifically, it is possible to configure the current position detection portion 6 using only the GPS sensor 61. The GPS sensor 61 detects the current position of the vehicle on the planet and the current time by receiving radio waves that are generated by artificial satellites. The geomagnetic sensor 62 detects the heading of the vehicle by measuring geomagnetism. The distance sensor 63 detects a distance between specified positions on a road. The distance sensor 63 may measure a revolution speed of a wheel of the vehicle and detect the distance based on the measured revolution speed, for example. However, the distance sensor 63 may also detect the distance by integrating the output of the vehicle speed sensor 67.

The steering sensor 64 detects a steering angle of the vehicle. For example, an optical rotation sensor that is attached to a rotating portion of the steering wheel, a rotational resistance sensor, an angle sensor that is attached to a wheel, or the like may be used as the steering sensor 64.

The gyroscopic sensor 65 detects a turning angle of the vehicle. For example, a gas rate gyroscope, a vibratory gyroscope, or the like may be used as the gyroscopic sensor 65. The heading of the vehicle can also be detected by integrating the turning angle that is detected by the gyroscopic sensor 65.

In the present embodiment, a case in which a hard disk is used as the map information processing portion 7 will be explained. The hard disk is provided with a function for reading a traffic information data base (hereinafter simply called a “DB”) 71, a map information DB 74, specified programs, and the like. Note that in the present embodiment, the hard disk is used as the map information processing portion 7, but other than the hard disk, a memory card, a DVD, an optical disk, or the like can also be used as an external storage device.

Congestion information 72 is stored in the traffic information DB 71. The congestion information 72 is created from road traffic information that pertains to current road congestion and the like and that includes the actual length of the congestion, the estimated time that the congestion will be resolved, and the like that are received from VICS 52. Traffic restriction information 73 is also stored in the traffic information DB 71. The traffic restriction information 73 is created from road traffic information that pertains to information on traffic restrictions and the like due to road work, building construction work, and the like. Note that in the present embodiment, the information in the traffic information DB 71 is not broadcast information from a broadcasting station, but is information that is obtained according to the VICS link ID. The device that enables a vehicle to be moved when a disaster occurs according to the present embodiment can also be set to receive broadcast information from at least one of JARTIC, an NHK (registered trademark) station in any part of the country, and a commercial broadcasting station, and a time for receiving the information can also be set.

Each road traffic information item that is received from VICS 52 includes the VICS link ID, along with information such as a disaster type, a disaster position, a length of a congested zone, a degree of congestion, and the like. The VICS link ID is an identification number that is assigned to a plurality of VICS link, the VICS links being standardized links into which a road is divided at specified intersections for the purpose of providing driving guidance. Note that the road traffic information for each VICS link includes the coordinates of the start point and the end point of the VICS link, the distance between the start point and the end point, and the like.

The information on roads that is stored in the map information DB 74 is not the same as the information on the VICS links. Specifically, the roads (links) are generally divided into smaller segments than the VICS links. Accordingly, the traffic information DB 71 includes a conversion table (a comparison table) of the VICS link IDs and the link IDs that are assigned as identification numbers the individual roads. This makes it possible to specify the link IDs based on the VICS link IDs. Therefore, receiving the VICS link ID from VICS 52 makes it possible for the navigation function to use the VICS link ID to specify a road segment for which road traffic information such as congestion information or the like should be displayed. Furthermore, the VICS link ID in the road traffic information that was received from VICS 52 and that pertains to the current road congestion or the like is converted to the link ID and stored as the congestion information 72. The VICS link ID in the road traffic information that was received from VICS 52 and that pertains to the traffic restriction information or the like is also converted to the link ID and stored as the traffic restriction information 73.

The map information DB 74 stores navigation map information 75 that is used for driving guidance and route searching by the navigation function of the device that enables a vehicle to be moved when a disaster occurs according to the present embodiment. The navigation map information 75 includes various types of information that are necessary for route guidance and map displays. For example, the navigation map information 75 may include new road information for specifying new roads, map display data for displaying maps, intersection data that pertains to individual intersections, branching point data that pertains to branching points, link data that pertains to roads that are a type of facility, route search data for route searching, shop data that pertains to points of interest (POIs) such as shops and the like that are a type of facility, search data for searching for geographical locations, and the like. The contents of the map information DB 74 are updated by downloading, through the communication portion 5, update information that is distributed from a map information distribution center.

The route search data includes data that is used in searching for and displaying a route to a set destination, cost data that is used in computing a search cost that includes the costs of passing through branching points and the costs of the links that make up the route, route display data for displaying, on a map on the display 3, a guidance route that is selected by a route search, and the like.

The shop data includes data that pertains to POIs in various regions, such as hotels, hospitals, gasoline stations, parking sites, tourist facilities, and the like, as well as IDs that specify the POIs. Note that the map information DB 74 also contains voice output data for outputting specified information through the speaker 4 of the device that enables a vehicle to be moved when a disaster occurs.

Next, a configuration of characteristic portions of the device that enables a vehicle to be moved when a disaster occurs according to the present embodiment will be explained.

A power supply 80 that includes a vehicle battery or the like inputs power to a constant voltage circuit 82 through an ignition switch 81 that is operated by an ignition key. The constant voltage circuit 82 supplies a constant voltage to the computation and control portion 1, the current position detection portion 6, and the map information processing portion 7.

The power supply 80 also inputs power to a constant voltage circuit 84 through a start switch 83. The constant voltage circuit 84 supplies a constant voltage to a disaster computation and control portion 86 that includes a microcomputer.

The output of the disaster computation and control portion 86 is input to a self-holding circuit 85 that is connected to both sides of the start switch 83. The output from the disaster computation and control portion 86 causes the self-holding circuit 85 to do self-holding irrespective of the operation of the start switch 83.

An earthquake sensor 88 includes a vibration sensor and a specified band filter. The vibration sensor detects at least one of the P waves and the S waves that are generated by an earthquake. The earthquake sensor 88 excludes from the vibration of the vehicle itself the vibration that is imparted to the vehicle from the road, such that it detects a comparatively low-cycle vibration.

Current position information that is computed by the current position detection portion 6 and the map information processing portion 7 is input to the disaster computation and control portion 86, along with distance information from the distance sensor 63, time information from the timer 15 in the form of a year-month-day date and an hour-minutes time, and the statuses of various flags. A constraint information storage portion 87 performs setting, deletion, and the like of a setting of the distance that the vehicle can be moved, a setting of the number of days that the vehicle can be moved, and a setting of the link level of the road by updating and inputting a password, an ID, and the like through communication with a control center that controls the vehicle. The device that enables a vehicle to be moved when a disaster occurs may receive notification of the occurrence of a disaster through communication with the vehicle control center. If the vehicle is within the area where the disaster has occurred, the vehicle control center may determine that the vehicle is subject to control at the same time that the engine stops, and the vehicle may also be deemed subject to control by the vehicle control center when the engine stops after the occurrence of a disaster has been detected by the vehicle.

Note that connecting a diode D that is indicated by a broken line in FIG. 1 makes it possible to utilize the navigation function, but in the present first embodiment, the navigation function is not used during a disaster response.

As shown in FIG. 4, the link levels of the roads are defined such that the link level 0 indicates a freeway class road (1), the link level 1 indicates a freeway class road (2), the link level 2 indicates a highway class road, the link level 3 indicates a throughway class road, the link level 4 indicates a local road class road, and the like. Thus the higher the number of the link level, the smaller the road becomes.

The disaster computation and control portion 86 of the device that enables a vehicle to be moved when a disaster occurs according to the present embodiment is controlled by the disaster detection program as described below. The disaster detection program is called and executed at specified intervals while a main program that controls the vehicle is being executed.

First, at step S1, a determination is made as to whether or not a disaster has occurred, based on one of whether a tremolo sound or the like has been received that is broadcast when a disaster occurs and whether the earthquake sensor 88 or the like has operated. If a disaster is not detected by either one of these methods, a disaster flag is turned off (set to zero), and the program is terminated.

If the occurrence of a disaster is detected at step S1 by one of the receiving of the broadcast that a disaster has occurred and the operating of the earthquake sensor 88 or the like, then at step S2, the current position information is input that was computed by the navigation function of the current position detection portion 6 and the map information processing portion 7. Next, at step S3, a determination is made as to whether the ignition switch 81 has been turned off by the ignition key. Steps S2 and S3 are executed until it is determined at step S3 that the ignition switch 81 has been turned off. When the ignition switch 81 is turned off, the current position of the vehicle is stored in memory at step S4.

Next, at step S5, the link level of the road is stored in memory. At step S6, the year-month-day date and the hour-minutes time are stored in memory.

At step S7, a determination is made as to whether a door of the vehicle is open, and at step S8, a determination is made as to whether a door of the vehicle is closed. These determinations are used to detect that the occupants, such as the driver and the like, have exited the vehicle. If it is confirmed that the occupants, such as the driver and the like, have exited the vehicle, based on the opening and the closing of a door of the vehicle at steps S7 and S8, all of the door locks of the vehicle are released at step S9. Next, at step S10, the disaster flag is turned on (set to 1) in order to store in memory the fact that the vehicle has detected the occurrence of the disaster and has stopped.

Next, the disaster computation and control portion 86 of the device that enables a vehicle to be moved when a disaster occurs according to the present embodiment is controlled by the disaster response program as shown in FIG. 3. The disaster response program is called by pressing the start switch 83 of the vehicle.

At step S21, a determination is made as to whether the start switch 83 has been pressed for at least five seconds. The time that serves as the basis for the determination is set to be not less than the start-up time of the constant voltage circuit 84 and the disaster computation and control portion 86. If the start switch 83 has not been pressed for at least five seconds at step S21, the program is terminated. If the start switch 83 has been pressed for at least five seconds at step S21, then at step S22 a determination is made as to whether or not the owner of the vehicle has input a specified password within a specified time, indicating that the vehicle is to be moved. If the owner of the vehicle has input the specified password, indicating that the vehicle is to be moved, a re-input prohibited flag is turned off (set to zero) at step S27, and the self-holding circuit 85 is closed (turned on) at step S28.

Once the self-holding circuit 85 is closed (turned on) in this manner, it becomes possible for the engine to be operated freely by operations of the constant voltage circuit 84 and the disaster computation and control portion 86, making it possible for the vehicle to operate without being affected by any constraint condition.

If it is not determined at step S22 that the owner of the vehicle has input the specified password within the specified time to indicate that the vehicle is to be moved, then a determination is made at step S23 as to whether the disaster flag is turned on (set to 1). If the disaster flag is not turned on, the subsequent steps are not executed.

If it is determined at step S23 that the disaster flag is turned on (set to 1), then a determination is made at step S24 as to whether the re-input prohibited flag is turned on (set to 1). The re-input prohibited flag is set to 1 at step S26 to store in memory the fact that the vehicle has been stopped by a constraint condition, so if the vehicle has been stopped by a constraint condition, the re-input prohibited flag is turned on at step S26.

Specifically, if the re-input prohibited flag is turned on, indicating that the vehicle has been stopped by a constraint condition, then the self-holding circuit 85 is opened (turned off) at step S29.

At step S24, if the re-input prohibited flag has been turned off (set to zero), it means that the vehicle has not been stopped by a constraint condition, so then at step S25, a determination is made as to whether or not any sort of requirement that constitutes a constraint condition has been imposed. If a requirement that constitutes a constraint condition has not been imposed, the re-input prohibited flag is turned off (set to zero) at step S27, and the self-holding circuit 85 is closed (turned on) at step S28.

However, in a case where it is determined at step S24 that the re-input prohibited flag has not been turned on (set to 1), but a constraint condition such as a time requirement or the like has been imposed, then the re-input prohibited flag is turned on (set to 1) at step S26, and the self-holding circuit 85 is opened (turned off) at step S29.

Once the self-holding circuit 85 is opened (turned off) in this manner, it becomes possible for the engine to be operated freely by operations of the constant voltage circuit 84 and the disaster computation and control portion 86, making it possible for the vehicle to operate within the scope of the imposed constraint condition.

FIG. 5 shows an example in which the constraint condition at step S25 is set to a range with a radius of approximately one kilometer. That means that a third party can move the vehicle within a range with a radius of approximately one kilometer from the position where the vehicle was stopped.

### Second Embodiment

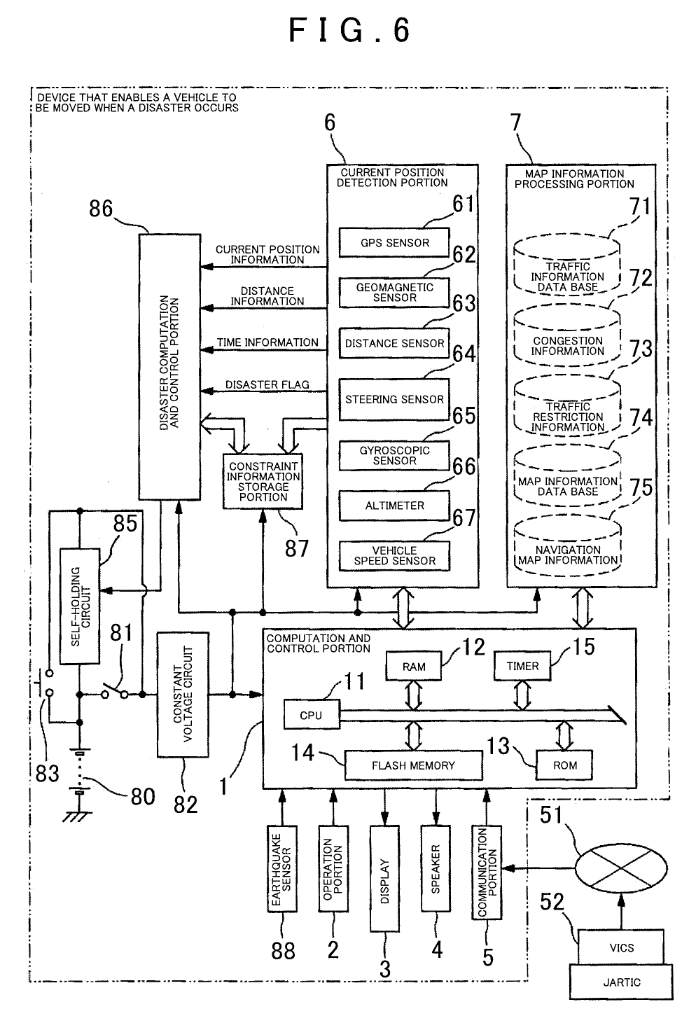

FIG. 6 is a block diagram that shows an overall configuration of a device that enables a vehicle to be moved when a disaster occurs according to a second embodiment of the present invention, in which the overall configuration includes an expression of a navigation function.

In the first embodiment, the navigation function is not used in responding to a disaster, but in the second embodiment, the constant voltage circuit 82 and the constant voltage circuit 84 are combined into a single circuit, so the navigation function can be used in responding to a disaster.

In the second embodiment, the disaster detection program that the disaster computation and control portion 86 executes when a disaster occurs and the disaster response program that allows the vehicle to be moved are no different from the programs shown in FIGS. 2 and 3 that are executed in the first embodiment, so explanations of the programs will be omitted.

Specifically, in the present embodiment, the navigation function of the disaster computation and control portion 86 can display a path from the current position where the vehicle stopped when the disaster occurred and can use a telephone network to inform the driver of the current position at specified distance intervals.

The device that enables a vehicle to be moved when a disaster occurs according to the first and second embodiments of the present invention, as described above, may be configured such that it includes a disaster occurrence detection unit, a vehicle stop detection unit, a forced engine start unit, and a constraint unit. The disaster occurrence detection unit incorporates step SI and detects the occurrence of a disaster. The vehicle stop detection unit incorporates step S3, detects that the vehicle's engine has stopped, and outputs a stop detection signal. The forced engine start unit incorporates steps S21 to S25, step S27, and step S28. After a disaster detection signal is received from the disaster occurrence detection unit that incorporates step S1, and after the vehicle stop detection unit that incorporates step S3 has detected that the vehicle has stopped moving, the forced engine start unit can use the start switch 83 to start the engine without using the ignition key. The constraint unit incorporates step S24, step S25, and step S28 and restricts the moving of the vehicle by the forced engine start unit.

Therefore, after the occurrence of a disaster is detected and the disaster detection signal is received, and after it has been detected at step S3 that the vehicle's engine has stopped, the engine can be started by the start switch 83 without using the ignition key. The movement of the vehicle is restricted by the constraint unit that incorporates step S24. Accordingly, when a disaster occurs, the disaster occurrence detection unit that incorporates step S1 outputs the disaster detection signal, the vehicle is stopped to allow the driver to evacuate, and the vehicle stop detection unit that incorporates step S3 outputs the stop detection signal. Then the forced engine start unit that incorporates steps S21 to S25, step S27, and step S28 is enabled to use the start switch 83 to start the engine without using the ignition key. Thus the engine is put into a state in which it can be started even in a case where the driver has removed the ignition key and fled. The abandoned vehicle can therefore be moved even by a third party who does not have the ignition key.

Furthermore, even in a case where the vehicle is moved by a third party who does not have the ignition key, the forced engine start unit that incorporates steps S21 to S25, step S27, and step S28 can be provided with a function that prevents the vehicle from being stolen, because the constraint unit that incorporates step S24 can restrict the movement of the vehicle by imposing a restriction such as a distance restriction, a restriction on the elapsed time since the vehicle stopped, a moving time restriction, a road link level restriction, a specific direction restriction, such as a homeward direction or the like, and the like.

Therefore, in a case where a need arises to move a vehicle that has been abandoned when a disaster occurs, it is possible for a third party to move the vehicle even if the ignition key has been removed, and it is also possible to prevent the vehicle from being stolen.

The disaster occurrence detection unit may be any unit that incorporates step S1 and detects the occurrence of a disaster. The disaster occurrence detection unit may be the earthquake sensor 88 that detects an earthquake directly and may also be a unit that receives the radio broadcast that a disaster has occurred. The use of the earthquake sensor 88 was explained in the embodiments described above, but in the practice of the present invention, a device that is equipped with an electrode that is made conductive by the presence of water at a specified position in the vehicle can be used as a flooding sensor, for example.

The vehicle stop detection unit may be any unit that incorporates step S3, detects that the vehicle's engine has stopped, and outputs the stop detection signal. In the present embodiment, a specific example will be explained in which the ignition key is not removed, but the vehicle stop detection unit can also detect that the engine has stopped if the ignition key is removed.

The device that enables a vehicle to be moved when a disaster occurs according to the first and second embodiments of the present invention, as described above, may also be configured such that it includes the disaster occurrence detection unit, the vehicle stop detection unit, a vehicle position storage unit, the forced engine start unit, and the constraint unit. The disaster occurrence detection unit incorporates step SI and detects the occurrence of a disaster. The vehicle stop detection unit incorporates step S3, detects that the vehicle's engine has stopped, and outputs a stop detection signal. The vehicle position storage unit incorporates step S4. After the disaster detection signal is received from the disaster occurrence detection unit that incorporates step S1, and after the vehicle stop detection unit that incorporates step S3 has detected that the vehicle has stopped moving, the vehicle position storage unit stores the position of the vehicle when the engine stopped. The forced engine start unit incorporates steps S21 to S25, step S27, and step S28. After the disaster detection signal is received from the disaster occurrence detection unit that incorporates step S1, and after the stop detection signal is received from the vehicle stop detection unit that incorporates step S3, the forced engine start unit can use the start switch 83 to start the engine without using the ignition key. The constraint unit incorporates step S24, step S25, and step S28 and restricts the moving of the vehicle by the forced engine start unit.

Therefore, once the disaster has occurred, and the disaster detection signal has been output by the disaster occurrence detection unit that incorporates step S1, and the driver has stopped the vehicle in order to evacuate, the vehicle stop detection unit that incorporates step S3 outputs the stop detection signal, so when the disaster detection signal and the stop detection signal are received, the vehicle position storage unit that incorporates step S4 stores the position of the vehicle. Then the forced engine start unit that incorporates steps S21 to S25, step S27, and step S28 is enabled to use the start switch 83 to start the engine without using the ignition key. Thus the engine is put into a state in which it can be started even in a case where the driver has removed the ignition key and fled. The abandoned vehicle can therefore be moved even by a third party who does not have the ignition key.

Furthermore, even in a case where the vehicle is moved by a third party who does not have the ignition key, the constraint unit that incorporates step S24 can restrict the moving of the vehicle by the forced engine start unit that incorporates steps S21 to S25, step S27, and step S28. The constraint unit restricts the moving of the vehicle by imposing a restriction such as a distance restriction, a restriction on the elapsed time since the vehicle stopped, a moving time restriction, a road link level restriction, a specific direction restriction, such as a homeward direction or the like, and the like, thus providing a function that prevents the vehicle from being stolen.

The vehicle position storage unit may be any unit that incorporates step S4 and stores position information after receiving the stop detection signal of the vehicle's engine. Therefore, in a case where a need arises to move a vehicle that has been abandoned when a disaster occurs, it is possible for a third party to move the vehicle even if the ignition key has been removed, and it is also possible to prevent the vehicle from being stolen.

The forced engine start unit may be any unit that incorporates steps S21 to S25, step S27, and step S28 and that can use the start switch 83 to start the engine without using the ignition key after the stop detection signal of the vehicle's engine is received from the vehicle stop detection unit. The start switch 83 can obviously be one of a key switch and a touch switch.

The constraint unit may be any unit that incorporates step S25, which restricts the moving of the vehicle, and restricts the moving of the vehicle by the forced engine start unit. The constraint condition may be that a specified time (days, hours, minutes) has elapsed since the stopping of the vehicle's engine was detected, that the vehicle has been moved a specified distance that is deemed necessary for road control during the disaster, that the vehicle is within a radius of a certain number of kilometers from the point where the vehicle stopped, and that the vehicle is moving in the direction of the owner's home, that is, that the radial distance between the position of the vehicle and the home that is registered in the navigation device is decreasing. The link level of the road on which the vehicle was traveling before it stopped can also be determined, and where the distance that the vehicle can be moved is used as the constraint condition, the distance that the vehicle can be moved can be set according to the link level. The constraint condition can also be that the vehicle is moving in such a direction that the link levels of the roads on which it is moving are decreasing.

In the device that enables a vehicle to be moved when a disaster occurs according to the embodiments described above, the disaster occurrence detection unit that incorporates step S1 can be configured from the earthquake sensor 88 that detects at least one of the P waves and the S waves that are generated by an earthquake and can also be configured from a unit that receives earthquake information that is broadcast by radio when an earthquake occurs, thereby detecting that the earthquake has occurred.

In the event of an earthquake, one of detecting a tremor and receiving a broadcast makes it possible for a disaster response is to be made, and because the disaster response can be made quickly in the case of a large-scale earthquake, the abandoned vehicle does not become an obstacle to recovery after the disaster.

The case of an earthquake has been explained here, but also in the event of road flooding, a tsunami, a landslide, or the like, the disaster can be recognized by voice recognition of information from an information center such as JARTIC, VICS, or the like. In the present embodiment, even if a disaster is detected at step S1, the driver can continue driving if he does not notice that the disaster has been detected. In other words, driving is still possible as long as the disaster does not create an obstacle to the passage of the vehicle. Therefore, the function of the present embodiment is operable even if takes the driver five minutes to recognize that the disaster has occurred.

In the device that enables a vehicle to be moved when a disaster occurs according to the embodiments described above, the constraint unit that incorporates step S24 may be a unit that stops the vehicle's engine in accordance with one of two constraint conditions. One of the constraint conditions may be that, in a case where the engine has been started by the forced engine start unit that incorporates steps S21 to S25, step S27, and step S28, the distance that the vehicle can be moved is restricted to a specified distance, and the other constraint condition may be that a specified time (days, hours, minutes) has elapsed since the stopping of the vehicle's engine was detected at step S3.

Note that any unit that measures the elapsing of the specified time since the stopping of the vehicle's engine was detected by the vehicle stop detection unit that incorporates step S3 can serve as the elapsed time measurement unit. Further, in a case where the engine has been started by the forced engine start unit that incorporates steps S21 to S25, step S27, and step S28, any unit that restricts the distance that the vehicle moves can serve as a movement distance restriction unit.

Therefore, because the vehicle's engine is stopped in accordance with one of the two constraint conditions, one of the conditions being that the specified time has elapsed since the stopping of the vehicle's engine was detected at step S3 and the other condition being that, in a case where the engine has been started by the forced engine start unit that incorporates steps S21 to S25, step S27, and step S28, the distance that the vehicle can be moved is restricted to a specified distance, the distance that the vehicle can be moved is limited. Thus, in a case where the driver searches for his own vehicle, the search can be done efficiently, because the driver needs to search only within a limited distance.

Furthermore, when the stopping of the vehicle's engine is detected by the vehicle stop detection unit that incorporates step S3, the constraint unit of the device that enables a vehicle to be moved when a disaster occurs according to the embodiments described above can, in accordance with a request from a member of a vehicle control center, entrust the control of the vehicle to the vehicle control center, which then monitors the vehicle. The starting of the engine by the forced engine start unit that incorporates steps S21 to S25, step S27, and step S28 is enabled by securing permission form the vehicle control center. That is, the constraint unit can make it a constraint condition that permission must be received from the vehicle control center. In this case, the vehicle control center can prevent the vehicle from being stolen, eliminating any concern that the vehicle will be stolen or lost by controlling the location to which the vehicle is moved.

When the engine is started by the forced engine start unit that incorporates steps S21 to S25, step S27, and step S28, the constraint unit of the device that enables a vehicle to be moved when a disaster occurs according to the embodiments described above can also set the distance that the vehicle can be moved in a range that is within a one kilometer radius from the position where the vehicle's engine stopped.

Therefore, because the distance that the vehicle can be moved is limited, in a case where the driver searches for his own vehicle, the search can be done efficiently, because the vehicle can be located within one hour in almost every case.

Note that in the first embodiment shown in FIG. 1, the navigation function is not operated, so the specified distance that the vehicle moves is measured. However, because the navigation function is operated in the second embodiment shown in FIG. 6, it is possible for the vehicle to be moved in a range that is within a specified radius from the position where the vehicle's engine stopped.

In the device that enables a vehicle to be moved when a disaster occurs according to the embodiments described above, if the constraint unit sets the specified elapsed time since the stopping of the vehicle's engine was detected by the vehicle stop detection unit that incorporates step S3 to no longer than ten days, the possibility that the vehicle will be stolen can be reduced, because the period during which the vehicle can be moved will not be inadvertently extended due to the state of recovery from a large-scale disaster.

The constraint unit of the device that enables a vehicle to be moved when a disaster occurs according to the embodiments described above may also include a voice guidance unit that provides voice guidance with regard to at least one of a remaining distance and a remaining time that the vehicle can be moved in a case where the engine has been started by the forced engine start unit that incorporates steps S21 to S25, step S27, and step S28. That is, providing guidance with regard to how much more the vehicle can be moved, such as “The vehicle can be moved another 500 meters,” for example, makes it possible for the vehicle to be moved to the nearest location where it will not be an obstacle. Because the guidance with regard to at least one of the remaining distance and the remaining time that the vehicle can be moved is provided in the form of at least one of a voice and a visual display, a third party who is driving the vehicle can understand at least one of the remaining distance and the remaining time that the vehicle can be moved and can therefore respond appropriately.

The constraint unit of the device that enables a vehicle to be moved when a disaster occurs according to the embodiments described above may also include a password input unit that incorporates step S22 and that uses the input of the specified password to cancel the constraint condition.

Inputting the password thus makes it possible for a legitimate driver to move the vehicle in the event of a disaster, even if the driver does not have the ignition key. The legitimate driver can therefore respond immediately, even if the ignition key has been lost or forgotten, without being affected by the constraint unit of the vehicle even if he does not search for the ignition key in an emergency situation when a disaster occurs.

In the device that enables a vehicle to be moved when a disaster occurs according to the embodiments described above, the vehicle stop detection unit that incorporates step S3 may determine the link level of the road on which the vehicle was traveling when it was detected that the vehicle's engine had stopped. This makes it possible for the constraint unit to set the constraint condition according to the link level of the road.

For example, in a case where a disaster is detected while the vehicle is traveling on a freeway class road (1), the navigation function can set the distance to one of an interchange and a parking area as the constraint condition, instead of setting a designated distance as the constraint condition. Obviously, the navigation function can also specify a location with a large capacity, such as the campus of a school or the like, as an evacuation site within a specified distance from an interchange. It is therefore possible to respond in a manner that is suited to the link level of the road, because the constraint condition that is set for the movement of the vehicle will vary according to the road on which the vehicle is stopped.

In the device that enables a vehicle to be moved when a disaster occurs according to the embodiments described above, when the vehicle stop detection unit that incorporates step S3 detects that the vehicle's engine has stopped, the vehicle stop detection unit may determine, at step S5, the link level of the road on which the vehicle was traveling. When the engine is started by the forced engine start unit that incorporates steps S21 to S25, step S27, and step S28 and the vehicle is moved, the constraint unit stops the vehicle if the road on which the vehicle is being moved has a higher link level than the road where the vehicle was stopped.

The link levels of the roads are defined such that the link level 0 indicates a freeway class road (1), the link level 1 indicates a freeway class road (2), the link level 2 indicates a highway class road, the link level 3 indicates a throughway class road, the link level 4 indicates a local road class road, and the like. The normal, common-sense way to evacuate is to move to roads with successively lower link levels. Therefore, in a case where the driver moves the vehicle in the opposite direction to a road with a higher link level, for example, the constraint unit determines that the vehicle is not being moved toward an evacuation site and prohibits further movement of the vehicle, thus making it harder to steal the vehicle.

The device that enables a vehicle to be moved when a disaster occurs according to the embodiments described above has been explained as a device that uses the navigation function to detect the current position of the vehicle. However, in the practice of the present invention, a device that does not have a navigation function can also be used, provided that the position of the vehicle is set to zero when the vehicle stop detection unit that incorporates step S3 detects that the vehicle's engine has stopped.

The above embodiments of the present invention have been explained as a matter of convenience using the ROAD CLASS (OUTSIDE JAPAN) described in FIG. 4. However, the present invention is not limited to the ROAD CLASS (OUTSIDE JAPAN), but can be applied to road class in various countries such as ROAD CLASS (JAPAN) described in FIG. 4 to adapt to the road conditions in Japan.

What is claimed is:

1. A device that enables a vehicle to be moved when a disaster occurs, comprising:
a disaster occurrence detection unit that detects the occurrence of a disaster;
a vehicle stop detection unit that detects that an engine of the vehicle has stopped;
a forced engine start unit that, after a disaster detection signal from the disaster occurrence detection unit and a vehicle engine stop detection signal from the vehicle stop detection unit are received, can use a start switch to start the engine without using an ignition key; and
a constraint unit that restricts the moving of the vehicle by the forced engine start unit.

2. The device that enables a vehicle to be moved when a disaster occurs according to claim 1, wherein
the disaster occurrence detection unit one of detects at least one of the P waves and the S waves that are generated by an earthquake and receives earthquake information that is broadcast by radio when an earthquake occurs.

3. The device that enables a vehicle to be moved when a disaster occurs according to claim 1, further comprising
an elapsed time measurement unit that measures the elapsing of a specified time since the stopping of the engine of the vehicle was detected by the vehicle stop detection unit; and
a movement distance restriction unit that specifies a distance that the vehicle can be moved in a case where the engine is started by the forced engine start unit,
wherein
the constraint unit stops the engine of the vehicle according to one of whether the specified time has elapsed since the stopping of the engine of the vehicle due to the detection of the occurrence of a disaster was detected and whether the vehicle has been moved the specified distance after the engine has been started by the forced engine start unit.

4. The device that enables a vehicle to be moved when a disaster occurs according to claim 1, wherein
the constraint unit, when the vehicle stop detection unit detects that the engine of the vehicle has stopped, entrusts control of the vehicle to a vehicle control center that controls starting of the engine of the vehicle, such that the starting of the engine by the forced engine start unit is enabled by receiving of permission from the vehicle control center.

5. The device that enables a vehicle to be moved when a disaster occurs according to claim 1, further comprising
a voice guidance unit that is included in the constraint unit and that provides voice guidance with regard to at least one of a remaining distance and a remaining time that the vehicle can be moved after the engine has been started by the forced engine start unit.

6. The device that enables a vehicle to be moved when a disaster occurs according to claim 1, further comprising:
a password input unit that is included in the constraint unit and that uses input of a specified password to cancel a constraint condition.

7. The device that enables a vehicle to be moved when a disaster occurs according to claim 1, wherein
a link level of the road on which the vehicle was traveling when the vehicle stop detection unit detected that the engine of the vehicle was stopped is determined, and
the constraint unit sets a constraint condition according to the link level.

8. The device that enables a vehicle to be moved when a disaster occurs according to claim 1, wherein
a link level of the road on which the vehicle was traveling when the vehicle stop detection unit detected that the engine of the vehicle was stopped is determined, and
the constraint unit, when the engine is started by the forced engine start unit and the vehicle is moved, stops the vehicle if the road on which the vehicle is being moved has a higher link level than the road where the engine of the vehicle was stopped.

9. The device that enables a vehicle to be moved when a disaster occurs according to claim 3, wherein
a link level of the road on which the vehicle was traveling when the vehicle stop detection unit detected that the engine of the vehicle was stopped is determined, and
the constraint unit sets a constraint condition according to the link level.

10. The device that enables a vehicle to be moved when a disaster occurs according to claim 9, wherein
a link level of the road on which the vehicle was traveling when the vehicle stop detection unit detected that the engine of the vehicle was stopped is determined, and
the constraint unit, when the engine is started by the forced engine start unit and the vehicle is moved, stops the vehicle if the road on which the vehicle is being moved has a higher link level than the road where the engine of the vehicle was stopped.

11. The device that enables a vehicle to be moved when a disaster occurs according to claim 4, wherein
a link level of the road on which the vehicle was traveling when the vehicle stop detection unit detected that the engine of the vehicle was stopped is determined, and
the constraint unit sets a constraint condition according to the link level. .12. The device that enables a vehicle to be moved when a disaster occurs according to claim 11, wherein
a link level of the road on which the vehicle was traveling when the vehicle stop detection unit detected that the engine of the vehicle was stopped is determined, and
the constraint unit, when the engine is started by the forced engine start unit and the vehicle is moved, stops the vehicle if the road on which the vehicle is being moved has a higher link level than the road where the engine of the vehicle was stopped.

13. A device that enables a vehicle to be moved when a disaster occurs, comprising:
a disaster occurrence detection unit that detects the occurrence of a disaster;
a vehicle stop detection unit that detects that an engine of the vehicle has stopped;
a vehicle position storage unit that stores the position of the vehicle when the vehicle stop detection unit detects that the engine of the vehicle has stopped after a disaster detection signal from the disaster occurrence detection unit has been received;
a forced engine start unit that, after the disaster detection signal from the disaster occurrence detection unit and a vehicle engine stop detection signal from the vehicle stop detection unit are received, can use a start switch to start the engine without using an ignition key; and
a constraint unit that restricts the moving of the vehicle by the forced engine start unit.

14. The device that enables a vehicle to be moved when a disaster occurs according to claim 13, wherein
the constraint unit limits a distance that the vehicle can be moved after the engine is started by the forced engine start unit to within a specified radius from the position where the engine of the vehicle stopped.

15. The device that enables a vehicle to be moved when a disaster occurs according to claim 13, further comprising:
a voice guidance unit that is included in the constraint unit and that provides voice guidance with regard to at least one of a remaining distance and a remaining time that the vehicle can be moved after the engine has been started by the forced engine start unit.

16. The device that enables a vehicle to be moved when a disaster occurs according to claim 13, further comprising:
a password input unit that is included in the constraint unit and that uses input of a specified password to cancel a constraint condition.

17. The device that enables a vehicle to be moved when a disaster occurs according to claim 13, wherein
a link level of the road on which the vehicle was traveling when the vehicle stop detection unit detected that the engine of the vehicle was stopped is determined, and
the constraint unit sets a constraint condition according to the link level.

18. The device that enables a vehicle to be moved when a disaster occurs according to claim 17, wherein
a link level of the road on which the vehicle was traveling when the vehicle stop detection unit detected that the engine of the vehicle was stopped is determined, and
the constraint unit, when the engine is started by the forced engine start unit and the vehicle is moved, stops the vehicle if the road on which the vehicle is being moved has a higher link level than the road where the engine of the vehicle was stopped.

19. The device that enables a vehicle to be moved when a disaster occurs according to claim 14, wherein
a link level of the road on which the vehicle was traveling when the vehicle stop detection unit detected that the engine of the vehicle was stopped is determined, and
the constraint unit sets a constraint condition according to the link level.

20. The device that enables a vehicle to be moved when a disaster occurs according to claim 19, wherein
a link level of the road on which the vehicle was traveling when the vehicle stop detection unit detected that the engine of the vehicle was stopped is determined, and
the constraint unit, when the engine is started by the forced engine start unit and the vehicle is moved, stops the vehicle if the road on which the vehicle is being moved has a higher link level than the road where the engine of the vehicle was stopped.
